(19) United States
(12) Patent Application Publication
(10) Pub. No.: US 2006/0287882 A1
(43) Pub. Date: Dec. 21, 2006

(54) Method for refilling a prescription product

(75) Inventors: Bryan L. Hansel, Overland Park, KS (US); Terence Pageler, Lenexa, KS (US)

Correspondence Address: Brett J. Trout, 516 Walnut, Des Moines, IA, 50309, US

(73) Assignee: Medical Industries America, Inc., Adel, IA (US)

(21) Appl. No.: 11/153,584

(22) Filed: Jun. 15, 2005

(51) Int. Cl. G06Q 10/00; G06F 7/00

(52) U.S. Cl. 705/2; 707/102

(57) ABSTRACT

A method for refilling a prescription product for a patient. A patient is diagnosed with a medical condition requiring a prescription product such as a continuous positive airway pressure (CPAP) system. At a predetermined time after delivery of the CPAP system, a provider forwards the patient a refill request postcard based upon the patient's particular CPAP system and insurance carrier's refill reimbursement policies. The patient executes and returns the postcard. The provider automatically processes the executed postcard, forwards the authorized refill products to the patient and obtains reimbursement from the patient's insurance carrier. The process continues, providing the patient with various authorized refill products, based upon the patient's insurance carrier's policies, until the refill authorization expires or the patient request cessation of delivery.

### BACKGROUND OF THE INVENTION

1. Field of the Invention

This invention relates to a method for dispensing prescription products and, more specifically to a method for facilitating the automated refill of patient prescription products.

2. Description of the Prior Art

It is generally known in the art to diagnose patients with a medical condition requiring treatment with a prescription device. One such device is a continuous positive airway pressure (CPAP) system used to treat sleep apnea. One drawback associated with prior art systems for providing CPAP systems to patients is the confusion surrounding the patient as to how often the patient's insurance carrier will reimburse replacement parts for the CPAP system. Typically, the insurance carrier will pay for replacement of items such as filters and hoses much more frequently that the blower unit. Determining the dates for replacement of these items and contacting the insurance company and durable medical equipment provider to replace different items at different times is a burdensome task. Often the task is more burdensome than simply continuing to use the old equipment. Unfortunately, continued use of the old equipment can lead to additional medical problems and/or a patient's decision to discontinue use of the CPAP system altogether. This not only harms the patient, but can also lead to drastically increased expenditures by the insurance company to address additional complications instigated by the patient failing to obtain replacement of the CPAP parts at the prescribed intervals. It would therefore be desirable to facilitate the delivery of CPAP parts to the patient at the prescribed intervals.

Another drawback associated with the prior art is the lack of verification and documentation associated with the delivery of CPAP parts to a patient at the prescribed intervals. It is known in the art to contact a patient via telephone to obtain authorization to send replacement CPAP parts. Although such systems lessen the burden on patient's to docket replacement dates, such systems also have their drawbacks. First, such systems provide little verification of patient identity. As most such systems are merely automated dialers, there are little or no procedures in place to verify a patient's identity prior to receipt of oral approval. In the event the automated dialer requires an authorization code, the authorization code is merely another impedance to the patient's receipt of the needed replacement products. If the patient forgets or misplaces the code, delivery of the needed replacement products may be unnecessarily delayed.

Yet another drawback with such prior art systems is the method in which oral authorizations are obtained and stored. As the transfer and storage of medical information is coming under tighter and tighter scrutiny, oral authorizations transmitted over a phone line may not comport with some present and future restrictions of the receipt and storage of medical information. Another problem with oral authorizations is that they are more obtrusive than textual authorizations and both the requester and patient must be available at the same time. If the requester is not able to receive the phone call at the exact time the requester calls, the patient cannot authorize the delivery of the needed products. Additionally, such oral authorizations are not as readily searchable or reproducible as standard textual authorizations.

Still another drawback with such prior art systems is the difficulty in providing information to patients and encouraging patients to reorder necessary supplies. Many statutes require written authorization from patients before using their information. If patients do not see any immediate benefit to such authorization, such authorization is often difficult to obtain. It would, therefore, be desirable to associate an authorization form with information a patient finds valuable in an effort to increase patient authorization response rates.

It would, therefore, be desirable to provide a patient with a system for obtaining an increased authorizations response rate for regularly providing a patient with information and replacement prescription products, wherein the system is simple, inexpensive, efficient, secure and easy to verify.

The difficulties encountered in the prior art discussed hereinabove are substantially eliminated by the present invention.

### SUMMARY OF THE INVENTION

In an advantage provided by this invention, a method is provided for dispensing refill prescription products which is simple and inexpensive.

Advantageously, this invention provides a method for dispensing refill prescription products which is quick and efficient.

Advantageously, this invention provides a method for dispensing refill prescription products which provides for an increased rate of patient authorizations for the receipt of information and refill prescription products.

Advantageously, this invention provides a method for dispensing refill prescription products which provides for simple storage, searching and retrieval of patient authorizations.

Advantageously, this invention provides a method for dispensing refill prescription products which speeds delivery of prescription products to patients and reimbursements to durable medical equipment providers.

Advantageously, in a preferred example of this invention, a method for refilling a prescription product for a patient is provided. The method comprises diagnosing the patient with a medical condition and providing the patient with a prescription product to treat the medical condition. At a predetermined time after delivery, the patient is provided a textual product refill request comporting with the patient's insurance carrier's policies for reimbursement for refill of prescription products. The patient authorizes and returns the textual product refill request. Delivery of a second prescription product to the patient is then authorized in response to receipt of the executed textual product refill request and a second prescription product is delivered to the patient.

Preferably, textual product refill requests continue to be sent to, and authorized by, the patient at regular intervals. Compliance with the patient's insurance carrier is confirmed regularly to assure the patient receives product refills at the prescribed intervals and receives reimbursement from the insurance carrier.

### BRIEF DESCRIPTION OF THE DRAWINGS

FIG. 1 illustrates a top perspective view of the CPAP kit of the present invention;

FIG. 2 illustrates a front perspective view of an alternative universally adaptable CPAP interface utilizing a full face mask;

FIG. 3 illustrates a front perspective exploded view of an alternative universally adaptable CPAP interface utilizing nasal pillows;

FIG. 4 illustrates a side perspective exploded view of an alternative universally adaptable CPAP interface utilizing an oral interface;

FIG. 5 illustrates a schematic of the interaction between the entities assisting the patient in determining an appropriate prescription product interface;

FIG. 6 A-D illustrates a flowchart of an exemplary process for dispensing a prescription product to a patient;

FIGS. 7 A-B illustrate the front and back of an initial contact postcard used in association with the method of the present invention.

FIG. 8A-B illustrate the front and back of a request postcard used in association with the method of the present invention.

### DETAILED DESCRIPTION OF THE PREFERRED EMBODIMENT

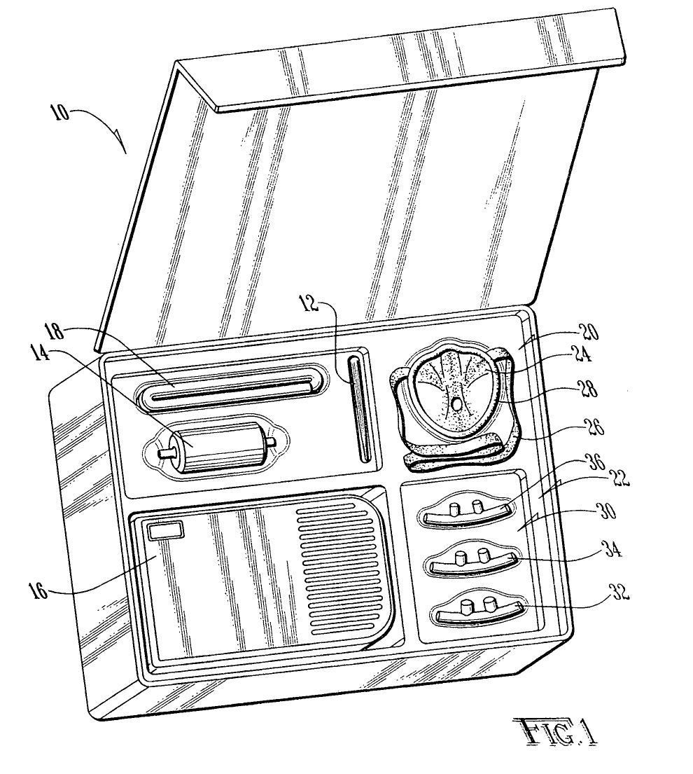

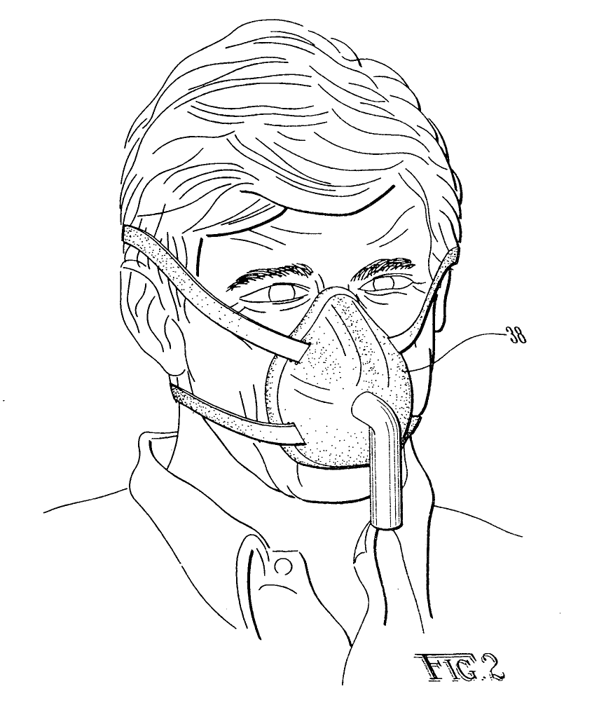

Although the prescription product of the present invention may be a delivery system, such as insulin, syringes or a consumable product, such as pills or topical treatments, in the preferred embodiment, the prescription product is a continuous positive airway pressure (CPAP) kit, shown generally as (10) in FIG. 1. The kit (10) preferably contains instructions (12) a filter (14) a blower (16) and a hose (18) such as those well known in the art. The kit (10) also contains a first CPAP interface (20) and a second CPAP interface (22).

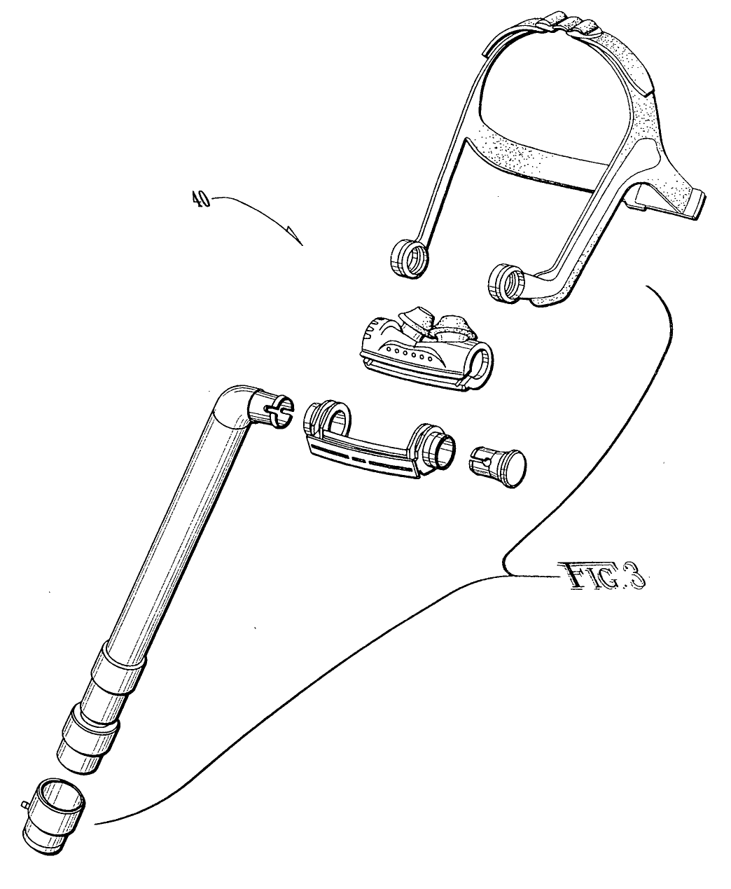

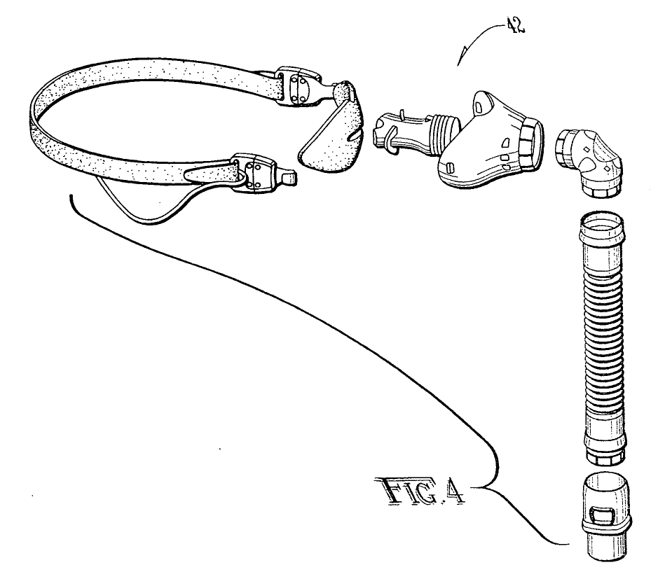

As shown in FIG. 1, the first CPAP interface (20) is of the “nasal mask” type being provided with a mask (24) and headgear (26). The nasal mask (24) is preferably of a “universal” fit type having a malleable triangular cushioned perimeter (28) which a patient can adjust to make larger or smaller or to more readily fit the patient's physiology. The second CPAP interface (22) is preferably a nasal canula (30), such as those known in the art. As nasal canulas (30) are typically not malleable, the kit is provided with six pairs of interfaces (34) (three of which are shown), ranging from a large interface (32) to a small interface (36), preferably provided on a blister pack or other sterile packaging. Although in the preferred embodiment, the first CPAP interface (20) is a nasal mask (24) and the second CPAP interface (22) is preferably a nasal canula (30), as shown in FIGS. 2-4, the CPAP interfaces (20) and (22) may be of any type known in the art, such as a full face mask (38), a nasal pillow system (40) an oral delivery system (42) or any other type of delivery system known in the art.

Preferably, both the first CPAP interface (20) and the second CPAP interface (22) are “universally adaptable” systems designed to adapt to a large number of patient physiological features. The universally adaptable feature may be the adjustability of the full face mask (38), the provision of various different sized interfaces for the nasal pillow system (40), the inherent adaptability to a large number of patients as is the case with the oral delivery system (42) or any other adaptability feature which reduces the need for a unique, customized interface. The fact that the CPAP interfaces (20) and (22) are systems designed to adapt to a large number of patient physiological features has a two-fold benefit. First, inventory is reduced as only a single kit is necessary to accommodate a broad range of patients. Second, the adaptability aids the patient in adjusting the system to patient's own physiological features and increases comfort and compliance by reducing the likelihood a patient will end up with an ill fitting or ineffective interface.

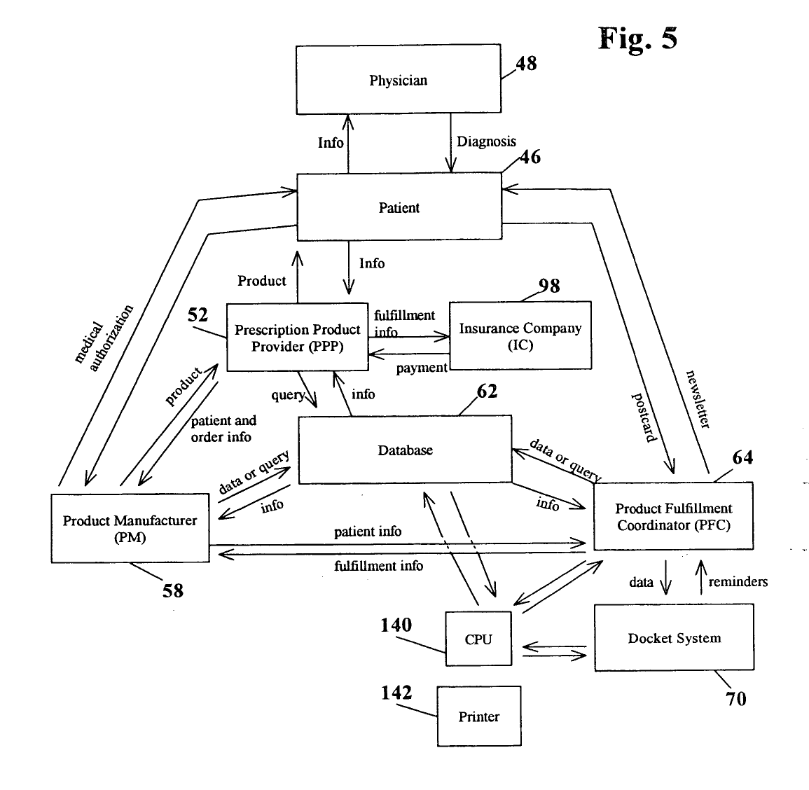

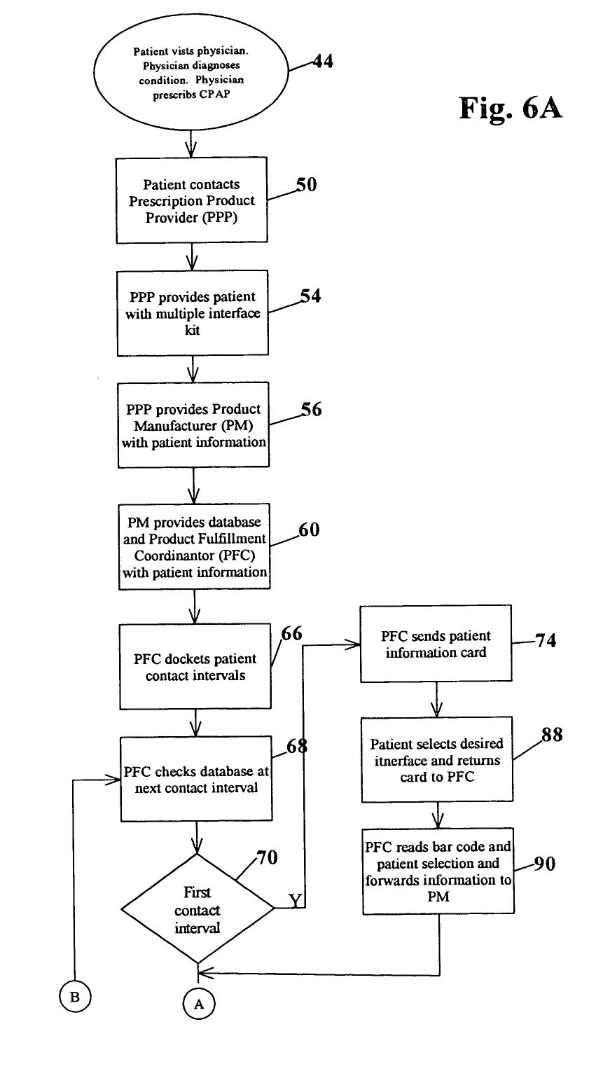

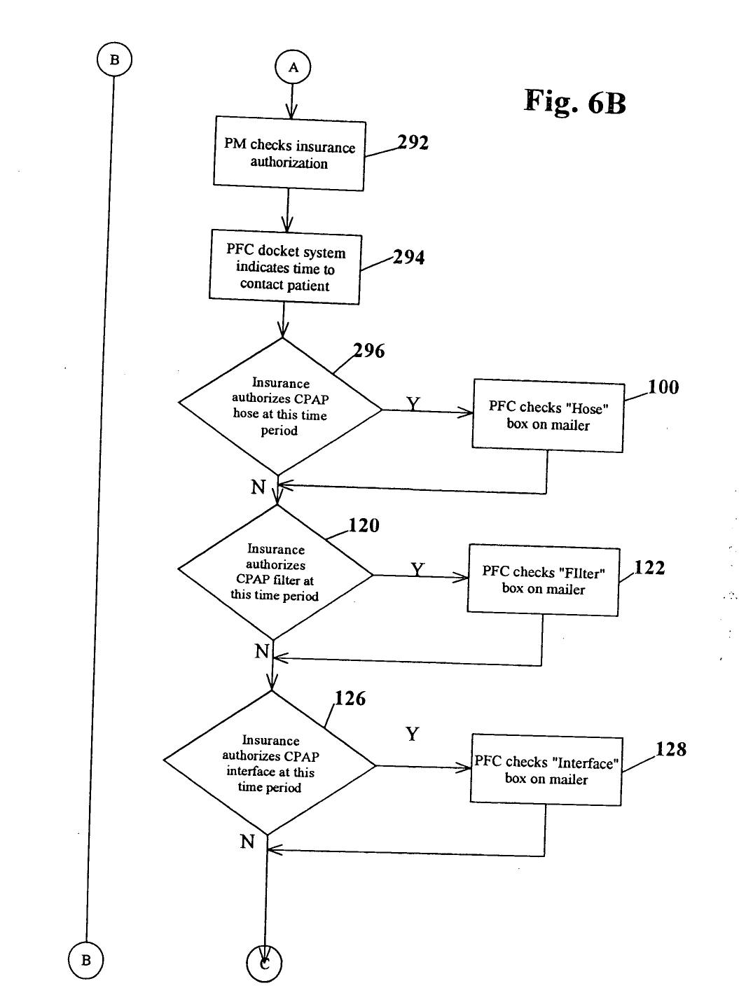

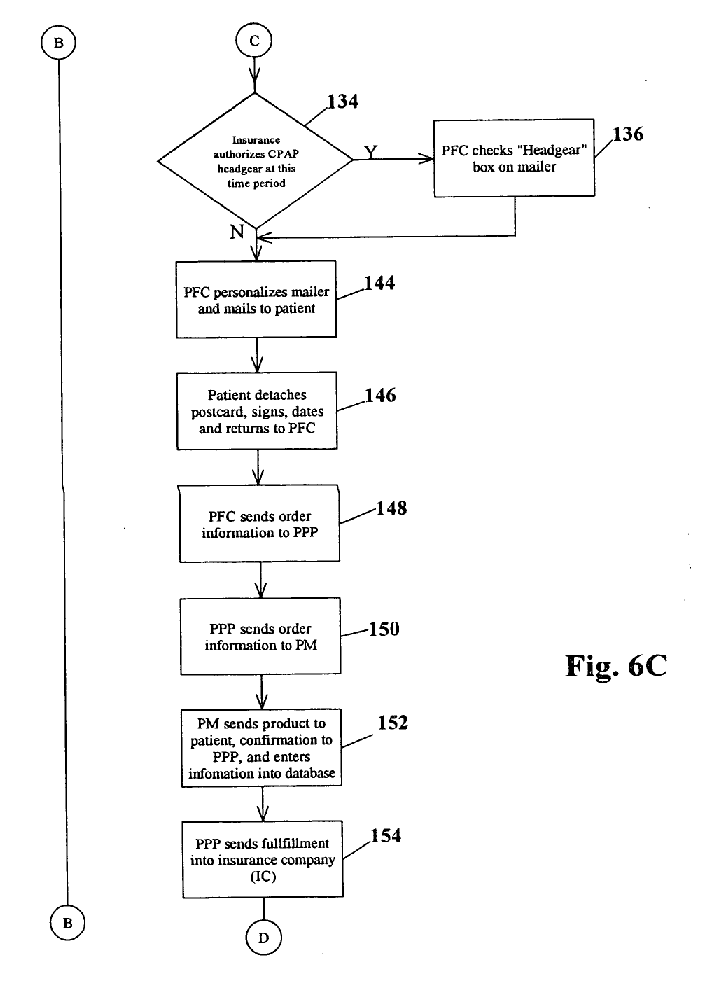

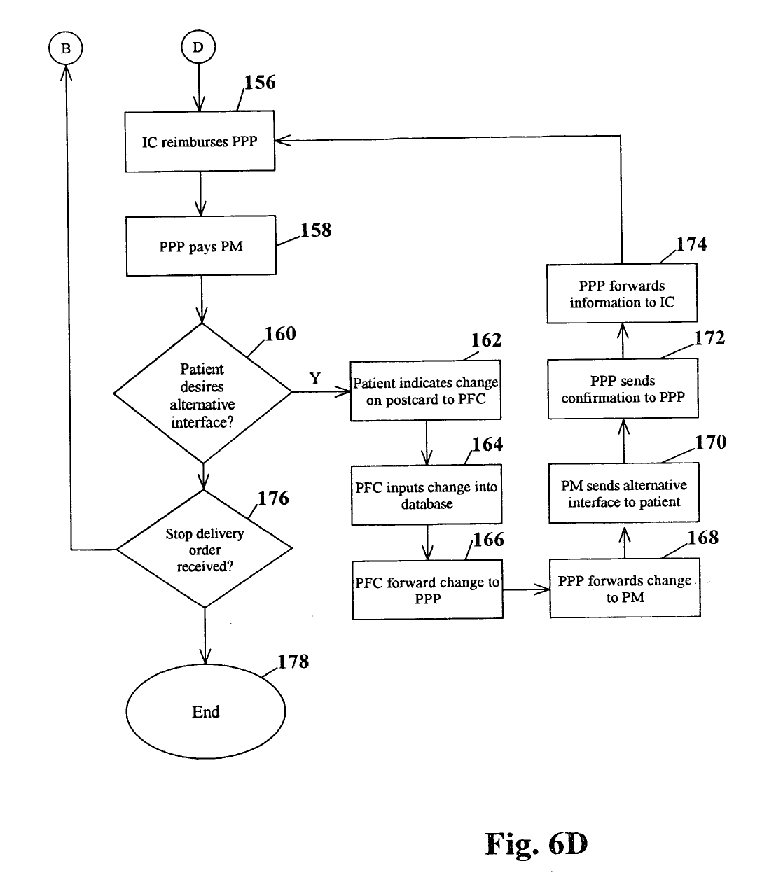

As shown in FIGS. 5 and 6A, the process of the present invention begins with step (44), where a patient (46) visits a physician (48), who prescribes an overnight sleep study in a sleep lab. The patient (46) participates in a study wherein data is collected by a sleep technician. The data is later reviewed by the physician (48) who diagnoses the patient (46) with a condition, such as obstructive sleep apnea, and prescribes a CPAP system for the patient (46).

In step (50), the patient (46) contacts a prescription product provider (PPP) (52), such as a durable medical equipment provider and provides the PPP (52) with the prescription and the patient's information, including insurance coverage information. In step (54), the PPP (50) provides the patient (46) with the CPAP kit (10), education about use of the CPAP kit (10), an introductory newsletter and a product renewal authorization. The product renewal authorization contains the patient's information and information regarding the patient's insurance authorized replenisment cycles. The patient (46) signs and returns the authorization to the PPP (50), and takes the CPAP kit (10).

In step (56) the PPP (52) provides the patient information and delivery date to the product manufacturer (PM) (58) of the kit (10). In step (60), the PM (58) enters the delivery date and patient information into a secure database (62) and provides the delivery date and patient information to a product fulfillment coordinator (PFC) (64).

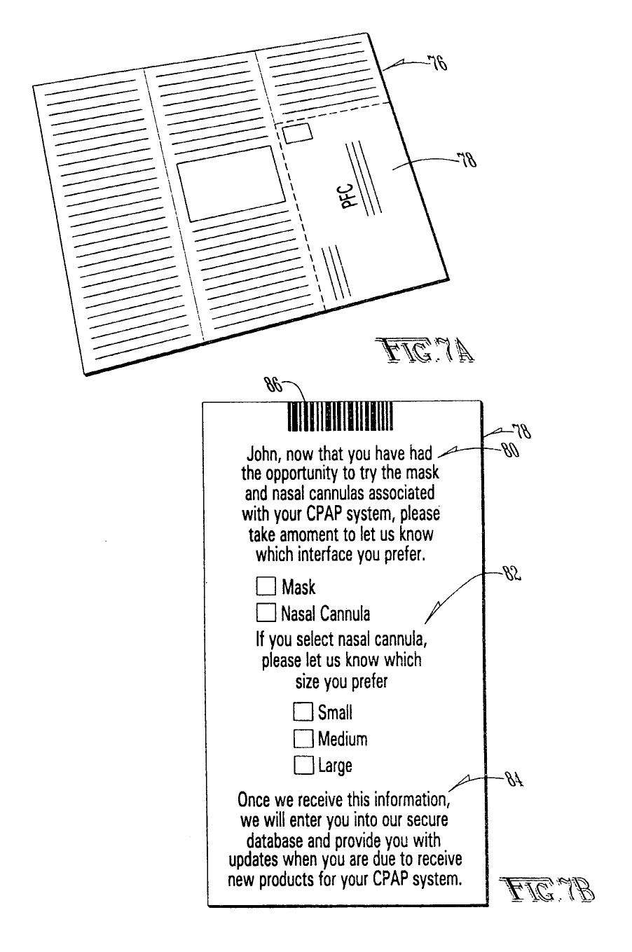

In step (66), the PFC (64) records the patient information and dockets the delivery date (FIG. 6A). Using the patient's insurance coverage information, the PFC (64) uses the delivery date to docket the dates the patient's insurance carrier is willing to pay to replace various components of the kit (10). In step (68), the PFC's computerized docket system (70) reminds the PFC (64) when it is time to contact the patient (40). In step (70), when it is time to contact the patient (40), the PFC (64) checks to see if this is the first time the PFC (64) has contacted the patient (46). If it is the first time the PFC (64) has contacted the patient (46), in step (74) the PFC (64) generates and sends the patient (46) an introductory newsletter (76) such as the one shown in FIG. 7A.

As shown in FIG. 7A, the introductory newsletter (76) contains a postage paid detachable patient introduction postcard (78) addressed to the PFC (64). The introductory newsletter (76) preferably provides information related to the CPAP kit (10). The more valuable this information, the less likely the patient is to discard the introductory newsletter (76) and the more likely the patient is to read the introductory newsletter (76). As shown in FIG. 7B the reverse side of the patient introduction postcard (78) contains a textual greeting (80), a response section (82), for the patient to indicate the patient's preference of interface, and instructions (84) for completing and returning the patient introduction postcard (78). If patient authorization has not already been obtained, the response section (82) may contain a signature requirement to authorize use of the patient's medical information. As many statutes require written patient authorization, the instant system has a significant advantage over prior art telephony based systems. The more valuable the information is on the introductory newsletter (76), the more likely the patient is to fill out and return the patient introduction postcard (78) which may authorize future contact with the patient and/or additional use of the patient's information. Valuable information on the introductory newsletter (76), the more the patient will look forward to the next newsletter and the more likely the patient will order additional supplies. The PFC (64) preferably provides the patient introduction postcard (78) with a barcode (86) associated with the patient (46). By the time the patient (46) has received the patient introduction postcard (78), the patient (46) has had sufficient time to determine a personal preference between the first CPAP interface (20) and the second CPAP interface (22).

In step (88), the patient (46) records the preferential prescription product on the patient introduction postcard (78) and mails the patient introduction postcard (78) to the patient (46) (FIGS. 6A and 7B). In step (90) the PFC (64) receives the patient introduction postcard (78), reads the barcode (86) with a scanner (not shown) such as those well known in the art and records the patient selection on the patient introduction postcard (78). The PFC (64) then transmits the information from the patient introduction postcard (78) to the PM (58), and records the patient's preferential prescription product information into the database (62). After the PFC (64) has recorded this information into the database (62) or if in step (72) it is not the first contact with the patient (46), the process moves to step (92) where the PM (58) checks the patient's insurance coverage and frequency of replacement of prescription products thereunder and relays this information to the PFC (64) (FIGS. 5 and 6A-B).

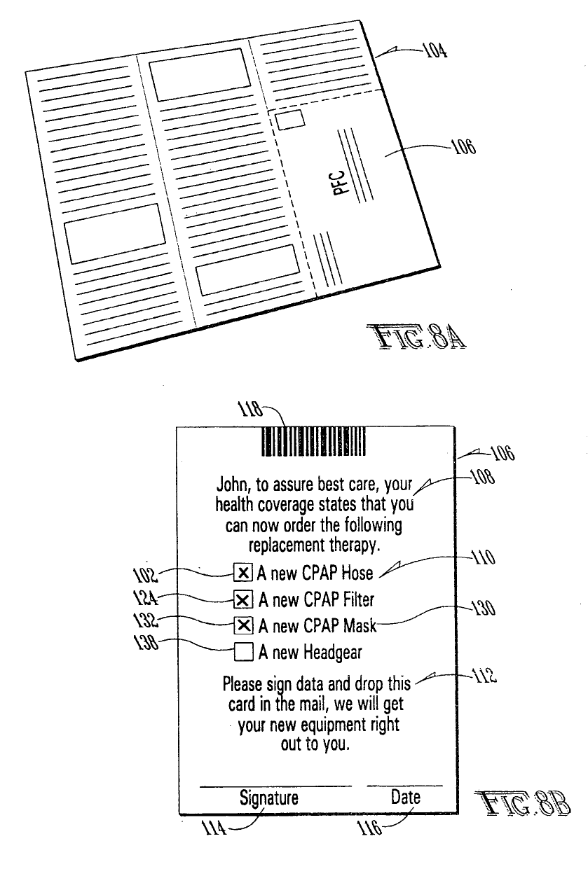

Once, as shown in step (94), monthly, the PFC (64) checks its docket system (70) to determine if it is time to contact the patient (46). In the event the docket system indicates it is time to contac the patient (46), the PFC (64) checks the patient's insurance-driven replenishment rates to determine and customize content in the patient's newsletter content. If the patient (46) is due for replenishment of a CPAP hose (18), the newsletter may be customized to extol the dangers of hose failure. The process moves to step (96) where the PFC (64) checks to see if the patient's insurance company (98) authorizes a new CPAP hose (18) for the patient (46) at this time period. If, as shown in step (100), the patient's insurance company (98) does authorize a new CPAP hose (18) for the patient (46) at this time period, the PFC (64) “checks” the box (102) marked “hose” on the detachable patient refill postcard (106) section of a refill newsletter (104) provided with by the PFC (64), such as the one shown in FIG. 8A. The refill postcard (106) is preferably postage paid and addressed to the PFC (64). As shown in FIG. 8B, the reverse side of the refill postcard (106) contains a textual greeting (108), a response section (110), preferably already filled out by the PFC (64), instructions (112) for completing and returning the refill postcard (106), and a patient signature line (114) and date line (116). The PFC (64) also preferably provides the refill postcard (106) with a barcode (118) associated with the patient (46).

As shown in FIGS. 6B and 8B, after the box (102) has been marked in step (100), or if the insurance company (98) does not authorize a new CPAP hose (18) for the patient (46) at this time period, the process moves to step (120) where the PFC (64) checks to see if the patient's insurance company (98) authorizes a new CPAP filter (14) for the patient (46) at this time period. If, as shown in step (122), the patient's insurance company (98) does authorize a new CPAP filter (14) for the patient (46) at this time period, the PFC (64) “checks” the box (124) marked “filter” on the refill postcard (106) section of a refill newsletter (104) (FIGS. 1, 5, 6B and 8A-B).

As shown in FIG. 6B, after the box (124) has been marked in step (100), or if the insurance company (98) does not authorize a new CPAP filter (14) for the patient (46) at this time period, the process moves to step (126) where the PFC (64) checks to see if the patient's insurance company (98) authorizes a new CPAP interface for the patient (46) at this time period. If the patient's insurance company (98) does authorize a new CPAP interface for the patient (46) at this time period, the PFC (64) queries the database (62) to determine the patient's preferential prescription product (130) previously identified by the patient (46) on the patient introduction postcard (78) and entered into the database (62) by the PFC (64). As shown in Step (128) the PFC (64) then inserts the name of the patient's preferential prescription product (130) on the refill postcard (106) and “checks” the box (132) adjacent the name of the patient's preferential prescription product (130). (FIGS. 1, 6B and 8A-B).

As shown in FIGS. 6B-C, after the box (132) has been marked in step (128), or if the insurance company (98) does not authorize a new CPAP interface for the patient (46) at this time period, the process moves to step (134) where the PFC (64) checks to see if the patient's insurance company (98) authorizes new CPAP headgear (26) for the patient (46) at this time period. If, as shown in step (136), the patient's insurance company (98) does not authorize new CPAP headgear (26) for the patient (46) at this time period, the PFC (64) does not “check” the box (138) marked “headgear” on the refill postcard (106) section of a refill newsletter (104) (FIGS. 1, 6C and 8A-B).

Although the foregoing steps may be implemented manually, in the preferred embodiment, the process is automatic, with the PFC (64) running a central processing unit (CPU) (140) such as those known in the art. As shown in FIG. 5, the CPU (140) is coupled to the docket system (70) and the database (62). The CPU (140) is also preferably coupled to a standard color printer (142). When the docket system (70) indicates it is time for the patient (46) to receive correspondence, the CPU (140) obtains the appropriate information from the docket system (70) and database (62) and generates the appropriate newsletter (76) or (104) personalized with the patient's name and other pertinent information (FIGS. 5 and 6A-D). The CPU (140) personalizes the postcard (78) or (106), as described above, with the patient's refill information and encodes the postcard (78) or (106) with appropriate postage and the barcode (86) or (118) identifying information on the postcard (78) or (106). The foregoing steps are, of course, only examples, as the process may be used to refill any number or type of prescription products such as pharmaceuticals, insulin delivery systems, diabetic maintenance supplies or any other prescription products.

As shown in step (144), once the refill newsletter (104) is prepared, the PFC (64) mails the refill newsletter (104) to the patient (46) (FIG. 6C). In step (146), the patient (46) receives the newsletter (104), detaches the refill postcard (106), signs and dates it as indicated and mails it back to the PFC (64). Upon receipt of the executed refill postcard (106), the PFC (64) checks for proper execution of the postcard (106) and reads the barcode (118) into the CPU (140). If desired, the entire postcard can be scanned in to the database (62) using optical character recognition software to facilitate the storage, retrieval and transmission of the authorizations contained thereon. In step (148), the PFC (64) forwards the order information from the executed refill postcard (106) to the PPP (52), which, as indicated in step (150), forwards the order information on to the PM (58).

Upon receipt of the order information, in step (152) the PM (58) sends the appropriate refill prescription products directly to the patient (46) and sends confirmation to the PPP (52) that the order has been received and product sent. Alternatively, the PM (58) could send the products to the PPP (52) which, in turn, forwarded the products to the patient (46). As shown in step (154), upon notice that the product has been sent, the PPP (52) forwards the information onto the patient's insurance company (98) for reimbursement. As shown in step (156), upon receipt of the reimbursement request, the patient's insurance company (98) reimburses payment to the PPP (52) (FIGS. 5 and 6D). Upon receipt of the reimbursement, in step (158) the PPP (52) pays the PM (58). Preferably the PM (58) pays the PFC (64) based upon volume, independent of receipt of any reimbursement.

As shown in step (160), if the patient (46) ever decides to try an alternative interface, such as the full face mask (38), the nasal pillow system (40), the oral delivery system (42) or any other system, the patient (46) in Step (162) indicates to the PFC (64) that an alternative interface is desired. The indication can be made on the refill postcard (106), by directly contacting the PFC (64) or PPP (52) or by any other desired means. Upon receipt of an alternative interface selection preference from the patient (46) in Step (164), the PFC (64) inputs the information into the database (62). In step (166), the PFC (64) forwards the alternative interface selection preference information to the PPP (52), which, as indicated in step (163), forwards the order information on to the PM (58).

After receipt of the alternative interface selection preference, at the appropriate time, in step (170) the PM (58) sends the alternative interface and associated prescription products directly to the patient (46) and in Step (172) sends confirmation to the PPP (52) that the alternative interface selection preference has been received and alternative interface and associated prescription products sent. As shown in step (174), upon notice that the alternative interface and associated prescription products have been sent, the PPP (52) forwards the information onto the patient's insurance company (98) for reimbursement. The process returns to step (156) where, upon receipt of the reimbursement request, the patient's insurance company (98) reimburses payment to the PPP (52) (FIGS. 5 and 6D). Upon receipt of the reimbursement, in step (158) the PPP (52) again pays the PM (58).

If the patient (46) dies does not desire an alternative interface, in Step (160), the process moves to Step (176). If the patient dies, or no longer wishes to receive prescription products, or fails to return a predetermined number of refill postcards (106), the PM (58) issues a stop delivery order. If as shown in step (178), a stop delivery order is received, the process terminates in step (180) and the PM (58) instructs the PFC (64) to stop providing newsletters (104) to the patient (46). If no stop delivery order is received, however, the process returns to step (68), where the PFC (46) awaits the next docket date to prepare and send a newsletter (104) to the patient (46).

Although the invention has been described with respect to a preferred embodiment thereof, it to be also understood that is not to be so limited, since changes and modifications can be made therein which are within the full, intended scope of this invention as defined by the appended claims. For example, it should be noted the PPP (52), PM (58) and PFC (64) may all be a single entity, with the process being automated and with barcode readers automatically entering information from incoming postcards (106) and automatically sending out newsletters at appropriate intervals. Additionally, alternative means of communication may be used, such as instant messaging, electronic mail, text messaging or any other type of textual communication.

What is claimed is:

1. A method for dispensing prescription products to a patient comprising the steps of:
(a) prescribing a first prescription product to said patient;
(b) delivering said first prescription product to said patient at a first time period;
(c) docketing a second period wherein said second time period is a predetermined time from said first time period;
(d) providing a textual product request to said patient at said second time period;
(e) said patient authorizing said textual product request;
(f) authorizing delivery of a second prescription product to said patient in response to said patient authorizing said textual product request; and
(g) delivering said second prescription product to said patient.

2. The method for dispensing prescription products to a patient of claim 1, further comprising encoding patient information on said textual product request.

3. The method for dispensing prescription products to a patient of claim 2, wherein said encoding is a barcode.

4. The method for dispensing prescription products to a patient of claim 1, further comprising:
(a) docketing a third time period wherein said third time period is a predetermined time from said first time period;
(b) providing a supplemental textual product request to said patient at said third time period;
(c) said patient authorizing said supplemental textual product request; and
(d) authorizing delivery of said third prescription product to said patient in response to said patient authorizing said supplemental textual product support.

5. The method for dispensing prescription products to a patient of claim 1, wherein said first prescription product is a different product than said second prescription product.

6. The method for dispensing prescription products to a patient of claim 1, wherein said second prescription product is a replaceable component of said first prescription product.

7. The method for dispensing prescription products to a patient of claim 1, wherein said first prescription product is a fluid mover.

8. The method for dispensing prescription products to a patient of claim 7, wherein said second prescription product is a fluid delivery interface.

9. The method for dispensing prescription products to a patient of claim 8, further comprising:
(a) docketing a third time period wherein said third time period is a predetermined time from said first time period;
(b) providing a supplemental textual product request to said patient at said third time period;
(c) said patient authorizing said supplemental textual product request; and
(d) authorizing delivery of said fluid delivery hose to said patient in response to said patient authorizing said supplemental textual product support.

10. The method for dispensing prescription products to a patient of claim 1, wherein said textual product request comprises a self-addressed piece of mail.

11. The method for dispensing prescription products to a patient of claim 10, wherein said step of said patient authorizing said textual product request comprises said patient signing said piece of mail, and said patient mailing said piece of mail.

12. A method for dispensing prescription products to a patient comprising the steps of:
(a) prescribing a prescription product to said patient wherein said prescription product is provided with a replaceable component;
(b) delivering said prescription product to said patient;
(c) docketing a replacement period for replacement of said replaceable component;
(d) generating a textual product request with information associated with said patient;
(e) providing said textual product request to said patient at said replacement period;
(f) said patient authorizing said textual product request;
(g) authorizing delivery of said replaceable component in response to said patient authorizing said textual product request; and
(h) delivering said replaceable component to said patient.

13. The method for dispensing prescription products to a patient of claim 12, wherein said patient information is graphically encoded on said textual product request.

14. The method for dispensing prescription products to a patient of claim 12, wherein said patient information is barcoded on said textual product request.

15. The method for dispensing prescription products to a patient of claim 14, further comprising the steps of:
(a) generating a database;
(b) inputting information on said database relating to said patient;
(c) inputting said replacement period into said database;
(d) reading said barcode subsequent to authorization of said textual product request by said patient; and
(e) inputting information from said barcode into said database.

16. The method for dispensing prescription products to a patient of claim 12, further comprising:
(a) generating a delivery approval in response to reading said barcode; and
(b) delivering said replaceable component to said patient in response to generation of said delivery approval.

17. The method for dispensing prescription products to a patient of claim 12, further comprising:
(a) docketing a supplemental replacement period for replacement of a supplemental replaceable component of said prescription product;
(b) encoding a supplemental textual product request with information associated with said patient;
(c) providing said supplemental textual product request to said patient of said supplemental replacement period;
(d) said patient authorizing said supplemental textual product request; and
(e) authorizing delivery of said supplemental replacement component in response to said patient authorizing said supplemental product request.

18. A method for dispensing prescription products to a patient comprising the steps of:
(a) prescribing a prescription product to said patient wherein said prescription product is provided with a replacement component;
(b) delivering said first prescription product to said patient;
(c) forwarding textual correspondence to said patient regarding said replacement component;
(d) adding a patient authorization to said textual correspondence; and
(e) delivering said replaceable component to said patient in response to receipt of said patient authorization.

19. The method for dispensing prescription products of claim 18, further comprising forwarding said textual correspondence to said patient after a predetermined period of time after delivering said first prescription product to said patient.

20. The method for dispensing prescription products of claim 18, further comprising reading information from said textual correspondence into a computer system.
